(19) United States
(12) Patent Application Publication
(10) Pub. No.: US 2017/0040701 A1
(43) Pub. Date: Feb. 9, 2017

(54) COMMUNICATION DEVICE, ELECTRONIC TIMEPIECE, AND ANTENNA DEVICE

(71) Applicant: CASIO COMPUTER CO., LTD., Tokyo (JP)

(72) Inventor: Toshio HANABUSA, Kanagawa (JP)

(73) Assignee: CASIO COMPUTER CO., LTD., Tokyo (JP)

(21) Appl. No.: 15/185,381

(22) Filed: Jun. 17, 2016

(30) Foreign Application Priority Data
Aug. 5, 2015 (JP) 2015-155440

(51) Int. Cl. H01Q 9/26; H01Q 7/00; H01Q 1/48

(52) U.S. Cl. CPC H01Q 9/265; H01Q 1/48; H01Q 7/00

(57) ABSTRACT

An antenna of an electronic timepiece includes a ring-shaped antenna pattern formed on a top surface or bottom surface of a cover glass and another antenna pattern that is formed beneath the ring-shaped antenna pattern and is capacitively coupled with the ring-shaped antenna pattern. The resonant frequency of the antenna is determined by the antenna patterns.

### BACKGROUND OF THE INVENTION

The present invention relates to a communication device, an electronic timepiece, and an antenna device.

When exchanging information between a wristwatch and other devices using radio waves or when receiving satellite radio waves to obtain the time or a time zone, the reception sensitivity of the antenna can pose a challenge. Using a larger antenna is one solution to improving the antenna reception sensitivity. However, wristwatches cannot be increased in size by any significant amount. Therefore, antennas that do not negatively impact the design aesthetics of a wristwatch are in demand.

Conventional wristwatches that receive satellite radio waves such Global Positioning System (GPS) signals typically use rectangle-shaped patch antennas or ring antennas made from a ring-shaped dielectric embedded in the bezel of the wristwatch in order to achieve the required gain and circular polarization properties for the antenna, for example. However, using a patch antenna or a ring antenna tends to increase the diameter or thickness of the wristwatch, thereby having a significant effect on the overall design aesthetics of the wristwatch.

The invention disclosed in Japanese Patent Application Laid-Open Publication No. 2015-8513 provides one example of a wristwatch that uses a dielectric ring antenna. The SOLUTION section in the abstract of this patent document discloses the following: “An electronic device 1 includes a GPS antenna 11 that receives externally sent radio waves; an outer case 101 made at least partially from a non-conductive material; a plate-shaped dial 2 made from a non-conductive material and housed within the outer case 101; a back cover 102 made from a conductive material and fixed to the outer case 101; and a receiver that is housed between the dial 2 and the back cover 102 within the outer case 101 and processes received signals according to the radio waves received by the GPS antenna 11. The GPS antenna 11 includes a line-shaped antenna electrode 112 arranged around the periphery of the dial 2. The back cover 102 is connected to the ground of the receiver and functions as a reflector that reflects the radio waves.”

The invention disclosed in this patent document makes it possible to arrange a ring antenna under a sheet of cover glass. However, this tends to increase the diameter or thickness of the wristwatch, thereby negatively affecting the design aesthetics of the wristwatch.

Accordingly, the present invention is directed to a scheme that substantially obviates one or more of the above-discussed and other problems due to limitations and disadvantages of the related art.

### SUMMARY OF THE INVENTION

Therefore, the present invention aims to provide a communication device, an electronic timepiece, and an antenna device that include a high-performance antenna that does not increase the size or thickness of the device housing.

Additional or separate features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, in one aspect, the present disclosure provides a communication device, including:

a communication module;

a cover glass covering the communication module and having a transparent window; and

an antenna,

wherein the antenna includes:
a first antenna pattern that is looped and formed on a top surface or a bottom surface of the cover glass; and
a second antenna pattern beneath the first antenna pattern and capacitively coupled with the first antenna pattern, and

wherein a resonant frequency of the antenna is determined by the first antenna pattern and the second antenna pattern.

In another aspect, the present disclosure provides an antenna device, including:

an antenna line for receiving radio waves from a satellite;

a feed line that is arranged beneath the antenna line and coupled with the antenna line;

a feed point that contacts the feed line; and

a ground line formed centered around a position that has been rotated in a direction +45° or +225° from the feed point about a prescribed rotational axis.

It is to be understood that both the foregoing general description and the following detailed description are exemplary and explanatory, and are intended to provide further explanation of the invention as claimed.

### BRIEF DESCRIPTION OF THE DRAWINGS

FIG. 1A illustrates the configuration of an electronic timepiece and an antenna thereof according to an embodiment of the present invention.

FIG. 1B illustrates the configuration of the electronic timepiece and the antenna thereof according to the embodiment.

FIG. 2 is an exploded perspective view illustrating the electronic timepiece according to the embodiment.

FIG. 3A is an enlarged cross-sectional view of the antenna.

FIG. 3B is a perspective view of a dial cover.

FIG. 4 schematically illustrates the configuration of the antenna and a circuit of the electronic timepiece.

FIG. 5 is an enlarged cross-sectional view of an antenna according to Modification Example 1.

FIG. 6 is an enlarged cross-sectional view of an antenna according to Modification Example 2.

FIG. 7A is an enlarged cross-sectional view of an antenna according to Modification Example 3.

FIG. 7B is a perspective view of a dial cover according to Modification Example 3.

FIG. 8A illustrates a position of the feed pin relative to the crown and side switches.

FIG. 8B is a cross-sectional view of the antenna in FIG. 7B along the line VIII-VIII.

FIG. 9A illustrates a method of achieving circular polarization in a glass antenna according to Modification Example 4.

FIG. 9B illustrates a method of achieving circular polarization in a glass antenna according to Modification Example 4.

FIG. 10 shows the RHCP radiation gain performance of Modification Example 4.

FIG. 11A illustrates a method of achieving circular polarization in a glass antenna according to Modification Example 5.

FIG. 11B illustrates a method of achieving circular polarization in a glass antenna according to Modification Example 5.

FIG. 12 shows the RHCP radiation gain performance of Modification Example 5.

FIG. 13A illustrates a method of achieving circular polarization in a glass antenna according to Modification Example 6.

FIG. 13B illustrates a method of achieving circular polarization in a glass antenna according to Modification Example 6.

FIG. 14 shows the RHCP radiation gain performance of Modification Example 6.

### DETAILED DESCRIPTION OF EMBODIMENTS

Next, an embodiment of the present invention will be described in detail with reference to figures.

In the present embodiment, the cover glass of an electronic timepiece is used as a dielectric material for the antenna in order to provide a high-performance antenna that does not increase the overall size or thickness of the electronic timepiece.

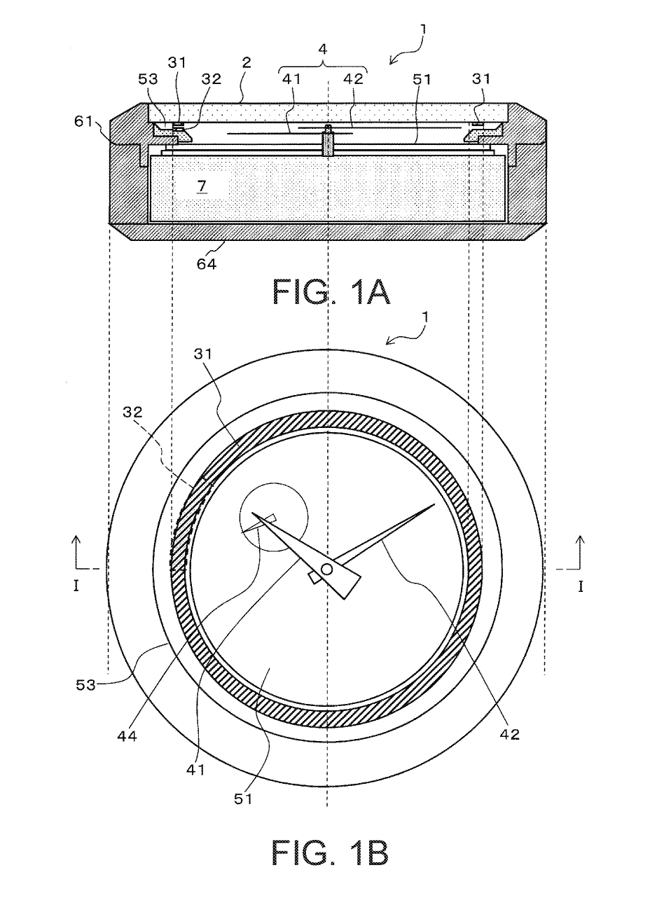

FIGS. 1A and 1B illustrate the configuration of an electronic timepiece 1 and an antenna 3 thereof according to the present embodiment.

FIG. 1A is a cross-sectional view of the electronic timepiece 1 taken along line I-I.

The electronic timepiece 1 is worn on the arm and therefore includes a time display unit 4 that includes components such as a dial 51, a long hand 42, and a short hand 41.

The electronic timepiece 1 also includes a metal case 6 constituted by a hollow cylinder-shaped, ring-shaped frame 61 and a back cover 64. Moreover, a cover glass 2 is fitted into an opening in the top surface of the ring-shaped frame 61, thereby forming a housing. The ring-shaped frame 61 and the back cover 64 are made from a conductive metal material such as brass, stainless steel, or a titanium alloy. Furthermore, the ring-shaped frame 61 and the back cover 64 are connected to the ground terminal of a clock module 7, which will be described next.

The clock module 7 is arranged within the housing of the electronic timepiece 1. The time display unit 4 that includes the components such as the dial 51, the long hand 42, the short hand 41, and a ring-shaped dial cover 53 (a ring-shaped member) is arranged above the clock module 7, facing the cover glass 2.

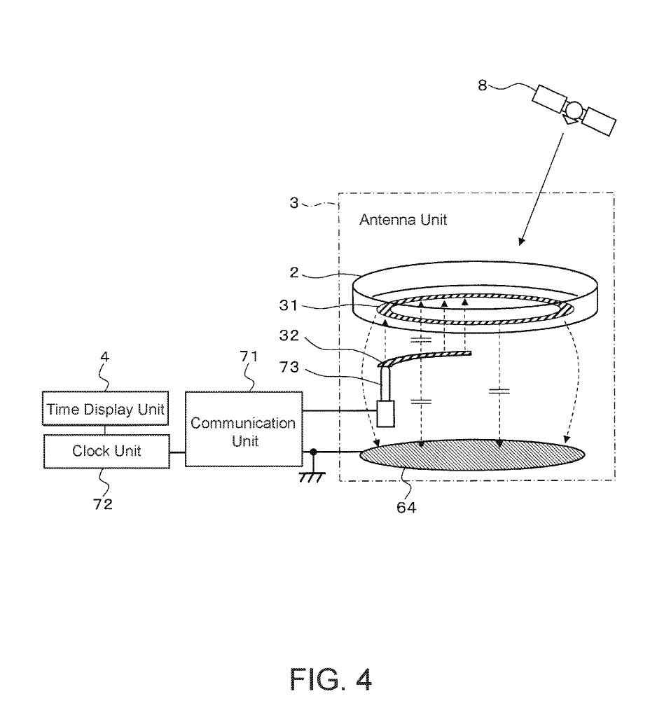

The clock module 7 drives the long hand 42 and the short hand 41 to display the time and also receives satellite signals from a GPS satellite 8 (see FIG. 4, which will be described later). Moreover, the clock module 7 includes components such as a circuit board (not illustrated in the figure) on which a circuit device that handles the processing for displaying the time and the GPS feature is mounted, a drive mechanism (not illustrated in the figure) that includes a step motor and a gear train for driving components such as the long hand 42 and the short hand 41, and a battery (not illustrated in the figure) that supplies power to the components listed above.

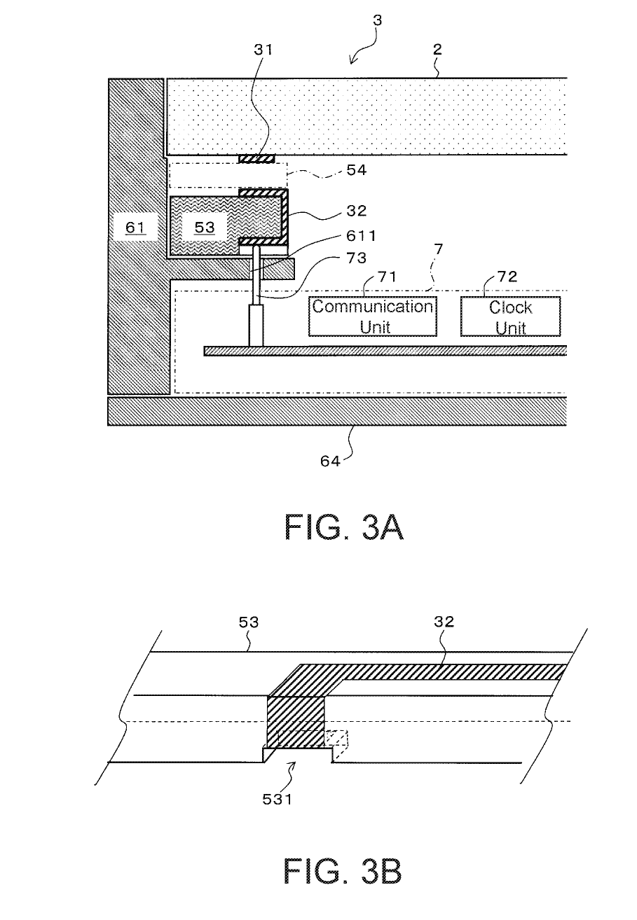

In the present embodiment, a ring-shaped antenna pattern 31 (a first antenna pattern) which is part of the antenna 3 (see FIG. 3A, which will be described later) is formed along the periphery of the bottom surface of the cover glass 2. Moreover, an antenna pattern 32 (a second antenna pattern) of a prescribed length and the same diameter as the antenna pattern 31 is formed directly below the antenna pattern 31 on the dial cover 53. In this way, the antenna pattern 32 is capacitively coupled with the antenna pattern 31.

The electronic timepiece 1 receives satellite signals from the GPS satellite 8 via the antenna 3, decodes the received satellite time information, and corrects the internal time information of the electronic timepiece 1.

FIG. 1B is a top view of the electronic timepiece 1.

The disk-shaped dial 51 is arranged in the center portion of the top surface of the electronic timepiece 1. The dial 51 is made from a non-conductive material such as a synthetic resin or a higher quality ceramic material that is formed into a disk shape, for example. The long hand 42, the short hand 41, and a small hand 44 or the like are arranged on the dial 51. The indicators such as the long hand 42, the short hand 41, and the small hand 44 are driven by the drive mechanism that includes the step motor and the gear train.

The ring-shaped dial cover 53 is arranged around the periphery of the top surface of the dial 51. The antenna pattern 32 is formed on the dial cover 53 and has a prescribed length along the peripheral direction thereof, and the circular antenna pattern 31 is formed above the antenna pattern 32 on the bottom surface of the cover glass 2.

In the present embodiment, the antenna pattern 31 (which is an electrode) is formed in a ring shape slightly inside of the outer periphery of the bottom surface of the cover glass 2 of the electronic timepiece 1. The antenna pattern 32 of the prescribed length is formed below the electrode of the antenna pattern 31 (on the dial cover 53, for example) and faces the antenna pattern 31, and power is capacitively fed to one end of the antenna pattern 32. In this way, the antenna pattern 31 functions as a feed unit for the antenna 3 (see FIG. 3). The metal case 6 of the electronic timepiece 1 functions as the ground plane of the antenna 3. This allows the electronic timepiece 1 to receive radio waves via the ring-shaped patch antenna.

The circumferential length of the antenna pattern 31 is substantially equal to the wavelength of the received radio waves in the cover glass 2. In other words, the length of the antenna pattern 31 is substantially determined by the permittivity of the cover glass 2 and the frequency of the received radio waves, and this length determines the resonant frequency of the antenna 3.

The capacitance of the antenna pattern 31 and the antenna pattern 32 is set such that the impedances thereof are matched at 50Ω. The circumferential length of the antenna pattern 32 may be set to approximately 30°, for example. Moreover, setting the pattern width of the antenna patterns 31 and 32 to less than or equal to 20 μm makes the antenna pattern 31 invisible to the naked eye, thereby having no effect on the design aesthetics of the electronic timepiece 1.

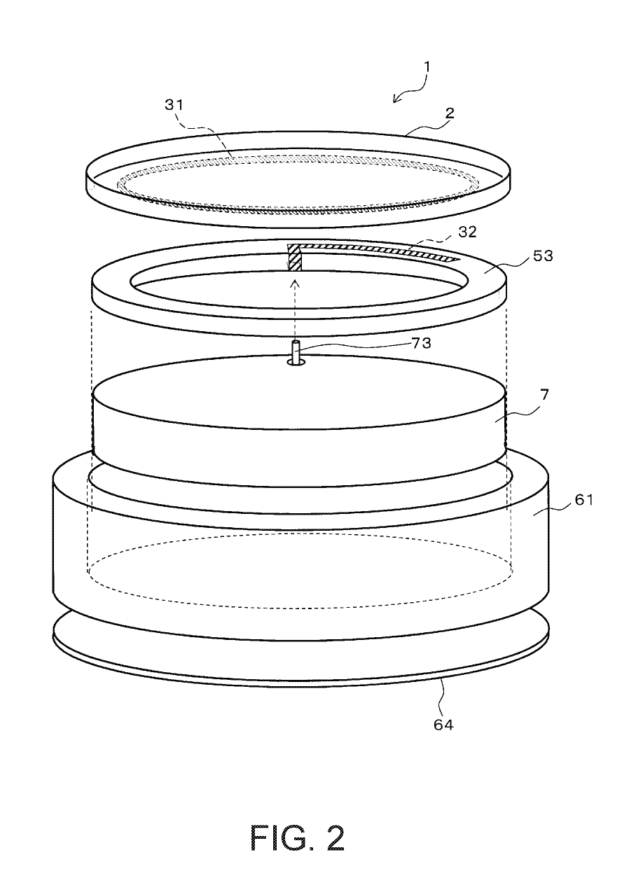

FIG. 2 is an exploded perspective view schematically illustrating the electronic timepiece 1 according to the present embodiment.

The electronic timepiece 1 includes, in order from top to bottom, the cover glass 2, the dial cover 53, the clock module 7 which is fitted into the opening in the top surface of the ring-shaped frame 61, and the back cover 64 that is fitted onto an opening in the bottom surface of the ring-shaped frame 61. Note that in this exploded perspective view, some of the components illustrated in FIG. 1 such as the dial 51 are not shown.

The antenna pattern 31 is formed in a ring shape on the bottom surface of the cover glass 2. The dial cover 53 is arranged below the antenna pattern 31, and the antenna pattern 32 of the prescribed length is formed on the top surface of the dial cover 53. One end of the antenna pattern 32 is connected to a feed pin 73, which is also connected to the interior of the clock module 7.

FIG. 3A is an enlarged cross-sectional view of the antenna 3.

The antenna pattern 31 is formed running along an area near the outer edge of the bottom surface of the cover glass 2. The antenna pattern 32 is formed facing the antenna pattern 31 on the top surface of the dial cover 53, and a portion of the antenna pattern 32 is also formed on the bottom surface of the dial cover 53. Moreover, as indicated by the dashed line, a non-conductive ring 54 made from a dielectric, for example, may be sandwiched between the cover glass 2 and the antenna pattern 32.

The end of the antenna pattern 32 formed on the bottom surface of the dial cover 53 is connected to the feed pin 73, which runs through a through hole 611 and is connected to a communication unit 71 inside the clock module 7. The feed pin 73 is formed in the clock module 7 and connects to the antenna pattern 32 via the through hole 611. The side faces of the feed pin 73 are insulated such that even if these side faces contact the ring-shaped frame 61, no power is conducted thereto.

The clock module 7 includes components such as the feed pin 73, the communication unit 71, and a clock unit 72. The electronic timepiece 1 receives satellite signals from the GPS satellite 8 via the antenna 3 that includes the antenna patterns 31 and 32. The communication unit 71 decodes satellite time information included in the satellite signals, thereby making it possible to display the correct current time.

FIG. 3B is an enlarged perspective view of the dial cover 53.

The majority of the antenna pattern 32 is formed on the top surface of the dial cover 53; however, a portion of the dial cover 53 is formed in a recess 531 in the bottom surface of the dial cover 53. The feed pin 73 contacts this recess 531, thereby making it possible to supply power to the antenna pattern 32. The recess 531 also makes it possible to easily detect the rotation angle of the dial cover 53 when assembling the electronic timepiece 1. Moreover, this notch 531 ensures that the antenna pattern 32 does not contact the ring-shaped frame 61 and conduct power thereto.

FIG. 4 schematically illustrates the configuration of the antenna 3 and a circuit of the electronic timepiece 1.

The antenna 3 is a ring-shaped patch antenna that includes the antenna pattern 31, the cover glass 2 that is made from a dielectric and determines the resonant frequency of the antenna pattern 31, the antenna pattern 32 that is capacitively coupled with the antenna pattern 31, the feed pin 73 that connects the antenna pattern 32 to the communication unit 71, and the housing that includes the back cover 64.

When radio waves are received from the GPS satellite 8, for example, the navigation data radio waves transmitted from the GPS satellite 8 resonate at a frequency that is determined by the permittivity of the loop-shaped antenna pattern 31 and the cover glass 2 as well as by the positional relationship of the back cover 64 relative to those components. The resulting power is first transmitted to the antenna pattern 32 due to the capacitive coupling between the antenna patterns 31 and 32 and then transmitted to the communication unit 71 via the feed pin 73. The communication unit 71 decodes the satellite time information from the received navigation data and then sends this satellite time information to the clock unit 72. The clock unit 72 then corrects the time displayed on the time display unit 4 according to the satellite time information.

The antenna 3 of the present embodiment does not require a substantial increase in volume of any of the antenna components, thereby making it possible to design the electronic timepiece 1 to be small and thin.

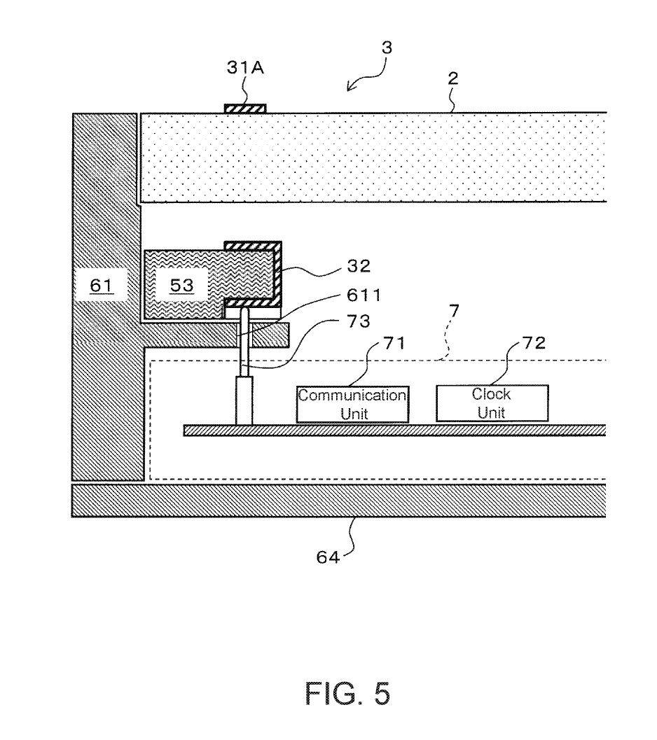

FIG. 5 is an enlarged cross-sectional view of an antenna 3 according to Modification Example 1.

In Modification Example 1, an antenna pattern 31A is formed on the top surface of a cover glass 2. The rest of the configuration is the same as in the embodiment described above.

In Modification Example 1, although the electrode of the antenna pattern 31A must be protected, the resulting antenna 3 exhibits the best performance out of the embodiment described above and Modification Examples 2 and 3, which will be described below.

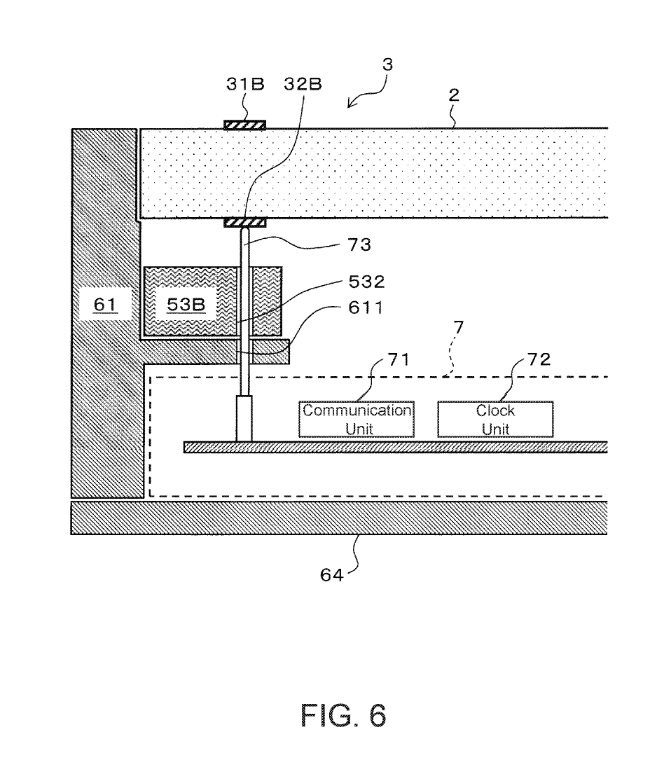

FIG. 6 is an enlarged cross-sectional view of an antenna 3 according to Modification Example 2.

In Modification Example 2, an antenna pattern 31B is formed on the top surface of a cover glass 2, and an antenna pattern 32B is formed on the bottom surface of the cover glass 2. A through hole 532 is formed in a dial cover 53B, and the antenna pattern 32B is connected to a feed pin 73 via this through hole 532.

In Modification Example 2, the distance between the antenna patterns 31B and 32B is fixed, thereby making it possible to reduce variations in the performance of the antenna.

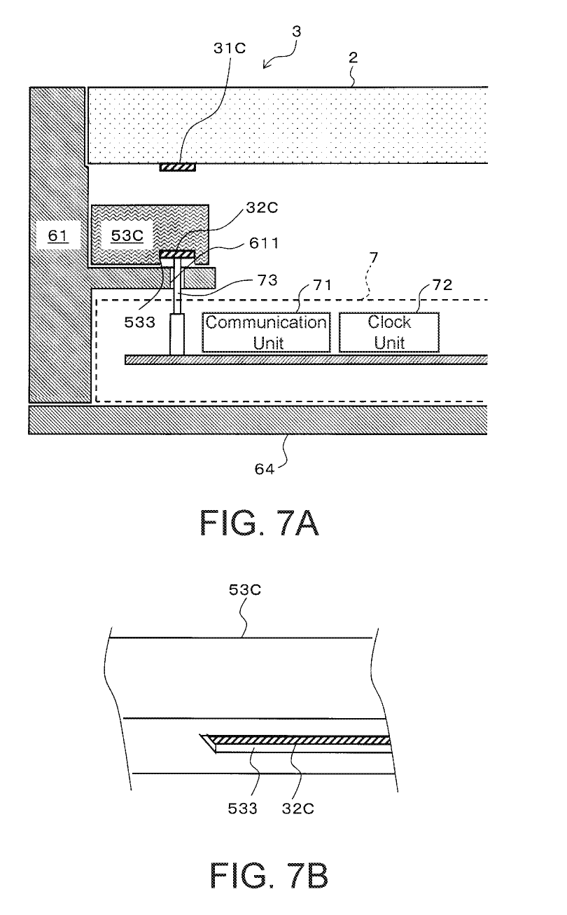

FIG. 7 includes an enlarged cross-sectional view of an antenna 3 and a perspective view of a dial cover 53C according to Modification Example 3.

In Modification Example 3, an antenna pattern 32C is formed beneath the dial cover 53C. More particularly, a groove 533 is formed in the bottom surface of the dial cover 53C, and the antenna pattern 32C is formed inside the groove 533.

In Modification Example 3, capacitance can still be adjusted as necessary, and the dial cover 53C has a simpler structure than the dial cover 53 illustrated in FIG. 3B, thereby making it possible to produce the component at a lower cost.

In Embodiment 1 and each of the modification examples described above, the case of the clock module 7 and the dial cover 53 may in most cases be made from a dielectric material. However, if the permittivity of these components is too high, the dielectric material may potentially affect the function of the antenna 3.

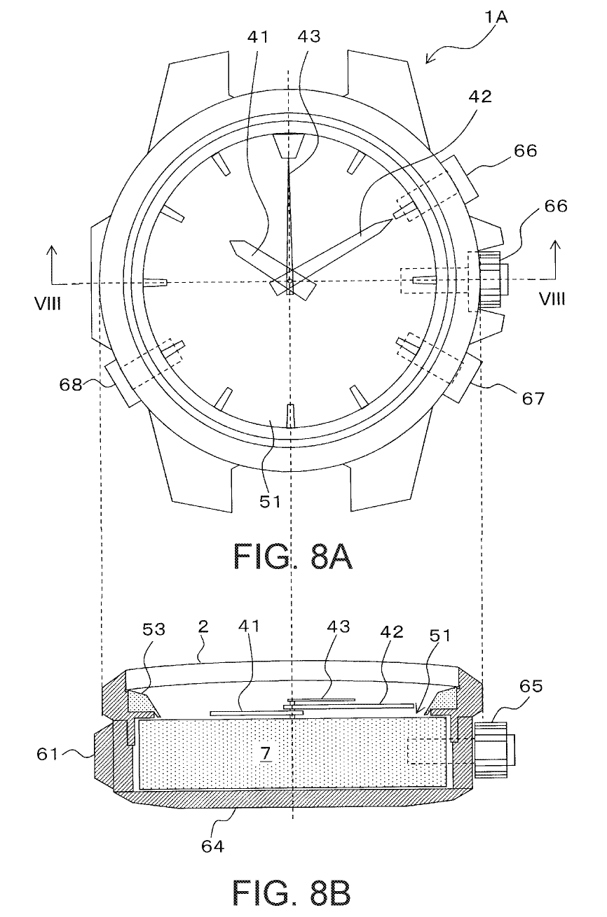

FIGS. 8A and 8B illustrate the structure of an analog wristwatch 1A.

FIG. 8A is a top view of the wristwatch 1A. Similar to the electronic timepiece 1 illustrated in FIG. 1B, a circular dial 51 is arranged in the center of the wristwatch 1A, and components such as a long hand 42 and a short hand 41 are arranged on the dial 51. The wristwatch 1A also includes a crown 65 arranged at the 3 o'clock position.

FIG. 8B is a cross-sectional view of the wristwatch 1A taken along line VIII-VIII.

In the wristwatch 1A, a back cover is fitted onto the rear surface of a hollow cylinder-shaped, ring-shaped frame 61, and a cover glass 2 is fitted into an opening in the top surface of the ring-shaped frame 61, thereby forming a housing. A clock module 7 is arranged within the housing of the wristwatch 1A. The shaft of the crown 65 extends into the interior of the clock module 7.

Therefore, a feed unit that includes a feed pin 73 of an antenna such as one of those illustrated in FIGS. 2, 3, and 5 to 7 is arranged at a position that is separated from at least the shaft of the crown 65 so that the feed unit does not positionally interfere with the shaft of the crown 65.

Furthermore, as illustrated in FIG. 8A, the analog wristwatch 1A includes a side switch 66 arranged at the 2 o'clock position, a side switch 67 arranged at the 4 o'clock position, and a side switch 68 arranged at the 8 o'clock position. Like the shaft of the crown 65, the mechanisms of the side switches 66 to 68 extend into the interior of the clock module 7. Similar side switches are often used in digital wristwatches as well.

Therefore, the feed unit that includes the feed pin 73 of an antenna such as one of those illustrated in FIGS. 2 and 3 is arranged at a position that is separated from the mechanisms of the side switches 66 to 68 so that the feed unit does not positionally interfere with these mechanisms. This makes it possible to improve the manufacturability of the wristwatch 1A and also makes it possible to reduce costs by simplifying the internal mechanisms.

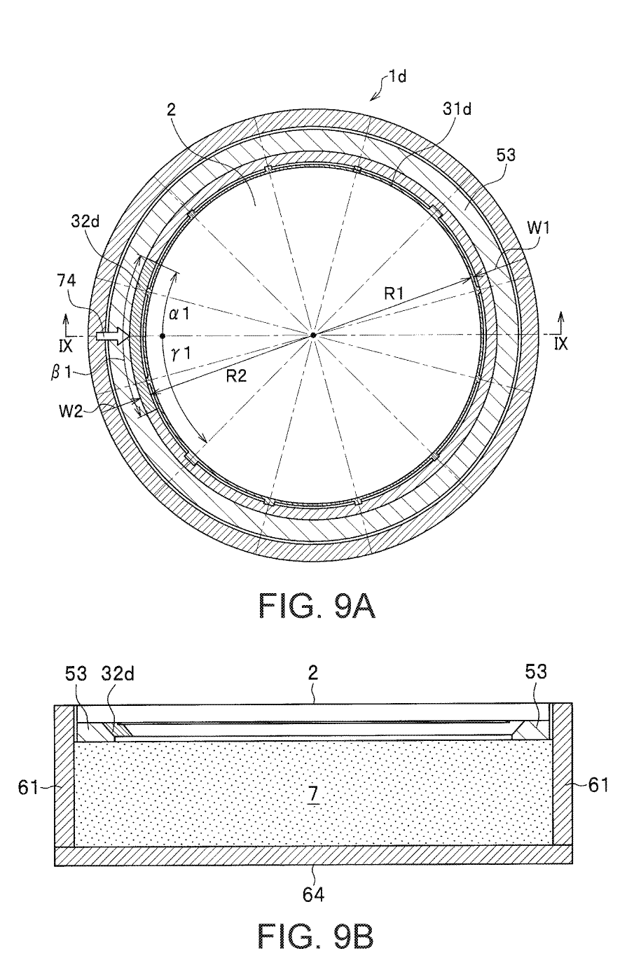

FIGS. 9A and 9B illustrate a method of achieving circular polarization in a glass antenna according to Modification Example 4.

FIG. 9A is a top view of an electronic timepiece 1d according to Modification Example 4.

As illustrated in FIG. 9A, a circular antenna pattern 31d that forms a radiating line in the electronic timepiece 1d is formed on the bottom surface of a cover glass 2. The radius R1 and the width W1 of the antenna pattern 31d are set according to the permittivity of the cover glass 2 such that that the antenna pattern 31e resonates at a required frequency F1. In Modification Example 4, assuming that the required GPS frequency is 1.57542 GHz and the relative permittivity εr of the cover glass 2 is 10, the radius R1=15.6 mm and the width W1=0.2 mm.

Furthermore, an arc-shaped antenna pattern 32d that has a radius of R2 and forms a feed line is arranged at the position shown on the left side of FIG. 9A.

FIG. 9B is a cross-sectional view of the electronic timepiece 1d according to Modification Example 4 taken along line IX-IX. The antenna pattern 32d is formed on the inner surface of a dial cover 53 arranged beneath the cover glass 2.

Next, FIG. 9A will be described in more detail. The antenna pattern 32d (the feed line) is capacitively coupled to the antenna pattern 31d (the radiating line) as appropriate. The magnitude of this capacitive coupling is determined by factors such as the width W2 of the antenna pattern 32d as well as an angle β1 that corresponds to the length of the antenna pattern 32d. Furthermore, a feed point 74 is formed at the center of the feed line, and the power supplied from the feed line to the radiating line due to the capacitive coupling therebetween is supplied symmetrically about the feed point 74.

To circularly polarize the antenna, for right-hand circularly polarized waves the pattern width of the radiating line should be increased at a position at a prescribed angle of γ1=+45° and/or +225° relative to the feed point 74 in order to increase the capacitance with the ground at that position. For left-hand circularly polarized waves, γ1=−45° and/or −225° relative to the feed point 74.

Furthermore, in Modification Example 4, portions with a slightly increased pattern width are formed at 30° intervals around the entire radiating line starting from a position at +45° relative to the feed point 74, and the widths and arc lengths of these portions are adjusted to achieve the appropriate impedance matching. Forming these portions of slightly increased pattern width at 30° intervals makes it possible to match the positions of these portions with the 12 hour positions of a clock, thereby making it possible to match the design of the clock face.

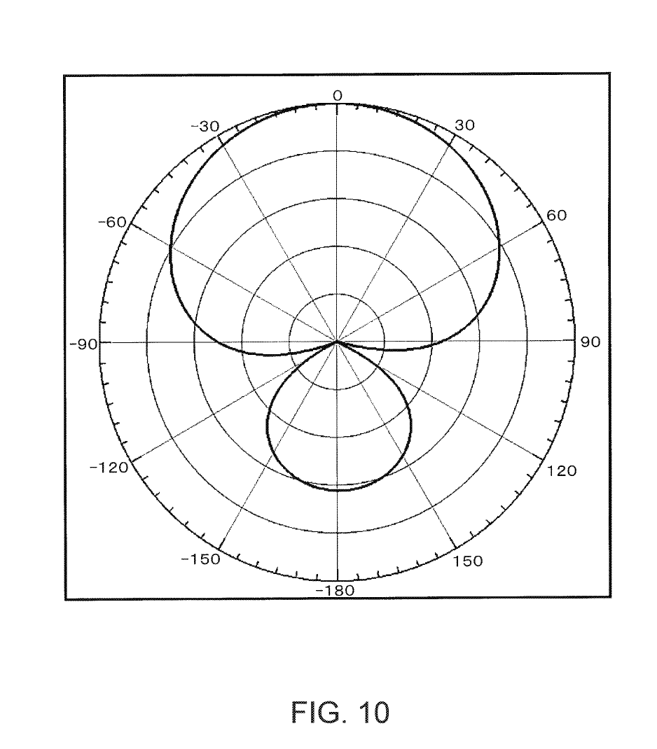

FIG. 10 shows the right-hand circularly polarized (RHCP) radiation gain performance of Modification Example 4. As shown in FIG. 10, Modification Example 4 exhibits sufficient gain performance for receiving right-hand circularly polarized waves, with the peak gain (0 dB) achieved in the zenith direction.

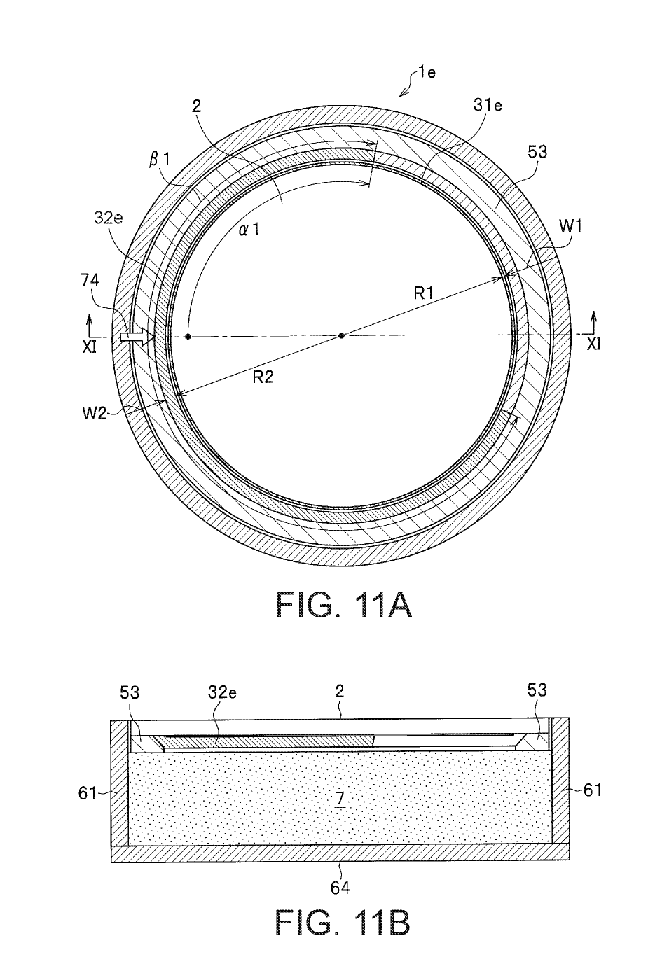

FIGS. 11A and 11B illustrate a method of achieving circular polarization in a glass antenna according to Modification Example 5.

As illustrated in FIG. 11A, an antenna pattern 31e that forms a radiating line in an electronic timepiece le is formed on the bottom surface of a cover glass 2, and the radius R1 and the width W1 of the antenna pattern 31e are set according to the permittivity of the cover glass 2 such that the antenna pattern 31e resonates at a required frequency F1.

FIG. 11B is a cross-sectional view of the electronic timepiece le according to Modification Example 5 taken along line XI-XI.

An arc-shaped antenna pattern 32e (a feed line) of radius R2 is formed on the inner surface of a dial cover 53 arranged beneath the cover glass 2.

Next, FIG. 11A will be described in more detail. The radius R2 of the antenna pattern 32e (the feed line) as well as an angle β1 that corresponds to the line length are set according to the permittivity ε1 of the dial cover 53 such that that the antenna pattern 32e resonates at a frequency F1. The feed line and the radiating line are capacitively coupled as appropriate, and the magnitude of this capacitive coupling is determined by factors such as the width W2 and the angle β1.

To circularly polarize this antenna, an angle al relative to a feed point 74 should be less than β1/2 (that is, α1<(β1/2)) for right-hand circularly polarized waves or greater than β1/2 (that is, α1>(β1/2)) for left-hand circularly polarized waves. In Modification Example 5, α1 is set to 100° (which is less than β1/2=127.5°) in order to receive right-hand circularly polarized waves.

Moreover, in Modification Example 5 the resonance of the feed pattern is used in order to achieve circular polarization, and therefore the relative permittivity εr of the dial cover 53 must satisfy formula (1) below.

<#1>

εᵣ≧[C₀/2πF₁R₂]² (1)

C₀: speed of light in vacuum

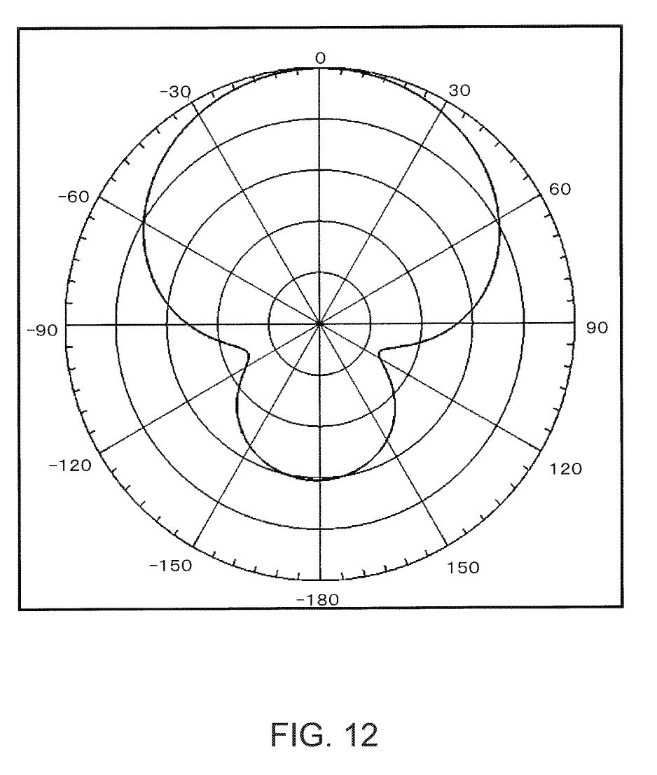

FIG. 12 shows the RHCP radiation gain performance of Modification Example 5. As shown in FIG. 12, Modification Example 5 exhibits sufficient gain performance for receiving right-hand circularly polarized waves, with the peak gain (0 dB) achieved in the zenith direction.

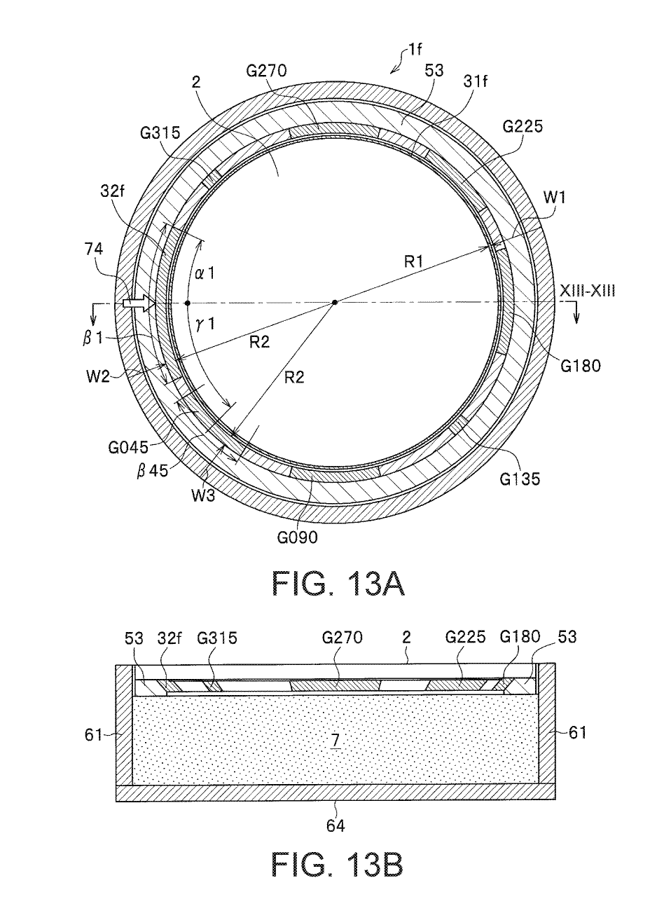

FIGS. 13A and 13B illustrate a method of achieving circular polarization in a glass antenna according to Modification Example 6.

As illustrated in FIG. 13A, an antenna pattern 31f that forms a radiating line in an electronic timepiece 1f is formed on the bottom surface of a cover glass 2, and the radius R1 and the width W1 of the antenna pattern 31f are set according to the permittivity of the cover glass 2 such that the antenna pattern 31f resonates at a required frequency F1.

Furthermore, an antenna pattern 32f that forms a feed line is arranged at the position shown on the left side of FIG. 13A.

FIG. 13B is a cross-sectional view of the electronic timepiece 1f according to Modification Example 6 taken along line XIII-XIII.

The antenna pattern 32f (the feed line) is arc-shaped with a radius of R2 and is formed in eight separate portions on the inner surface of a dial cover 53 arranged beneath the cover glass 2.

Next, FIG. 13A will be described in more detail. The antenna pattern 32f (the feed line) is capacitively coupled to the antenna pattern 31f (the radiating line) as appropriate. The magnitude of this capacitive coupling is determined by factors such as the width W2 of the antenna pattern 32f as well as an angle β1 that corresponds to the length of the antenna pattern 32f. In Modification Example 6, the angle β1=50°.

Furthermore, a feed point 74 is formed at the center of the feed line, and the power supplied from the feed line to the radiating line due to the capacitive coupling therebetween is supplied symmetrically about the feed point 74.

To circularly polarize this antenna, for right-hand circularly polarized waves, ground patterns G045 and G225 of a prescribed width W3 and angle β45 are formed at a position of γ1=+45° and/or +225° relative to the feed point 74. This increases the capacitance with the antenna pattern 31f (the radiating line), thereby circularly polarizing the antenna. For left-hand circularly polarized waves, ground patterns of a prescribed width W3 and angle β45 may be formed at a position of γ1=31 45° and/or −225° relative to the feed point 74. In Modification Example 3, the angle β45 is set to 26° at the positions at γ1=+45° and +225.

Furthermore, in Modification Example 6, the antenna pattern 32f is divided at 45° intervals around the entire circumference thereof starting from the feed point 74, and ground patterns G045, G090, G135, G180, G225, G270, and G315 are formed at the corresponding positions. The widths and arc lengths of each these portions are adjusted to achieve the appropriate impedance matching. Adjusting the lengths and widths of these radiating patterns and ground patterns makes it possible to fine-tune the antenna frequency as well as adjust the circular polarization characteristics and impedance properties of the antenna without having to change the antenna pattern 31f.

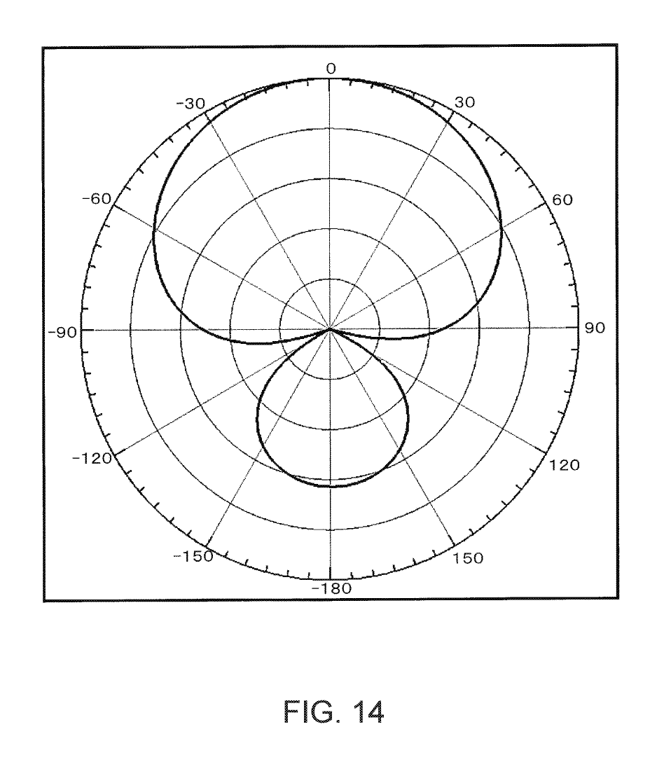

FIG. 14 shows the RHCP radiation gain performance of Modification Example 6. As shown in FIG. 14, Modification Example 6 exhibits sufficient gain performance for receiving right-hand circularly polarized waves, with the peak gain (0 dB) achieved in the zenith direction.

As described above, conventional patch antennas and ring antennas tend to affect the size and thickness of the device housing. In at least one aspect of the present invention, the timepiece housing itself functions as an antenna, and therefore the antenna structure either does not increase the size of the timepiece at all or only increases the size of the timepiece by a very small amount, while also making it possible to provide a wristwatch antenna with excellent performance. The antenna of the present embodiment does not require a substantial increase in volume of any of the antenna components, thereby making it possible to design a small, thin timepiece.

### MODIFICATION EXAMPLES

The present invention is not limited to the embodiments described above, and various modifications can be made without departing from the spirit of the present invention. For example, modifications such as (a) to (e) below are possible.

(a) The present invention is not limited to an analog electronic timepiece and may also be applied to a digital electronic timepiece. In this case, the antenna pattern 31 and the antenna pattern 32 may be arranged around the periphery of a liquid crystal panel, for example.

(b) The antenna pattern 31 does not necessarily have to be circular in shape. The antenna pattern 31 may be any polygonal shape including quadrilaterals or may be irregular in shape.

(c) The present invention is not limited to electronic timepieces and may be applied to any communication device.

(d) The antenna communication standard and frequency bands that can be used for communication are not limited to GPS or ultra high frequencies. The antenna may use any communication standard/frequency band suitable for use in a communication device. In other words, communication standards such as Bluetooth (registered trademark) and Wi-Fi (registered trademark) as well as the frequency bands used for these communication standards may be used.

(e) Any configuration in which the antenna pattern 31A is formed on a glass surface may be used, or the antenna pattern 31A may be integrated into existing timepiece components such as the bezel ring.

It will be apparent to those skilled in the art that various modification and variations can be made in the present invention without departing from the spirit or scope of the invention. Thus, it is intended that the present invention cover modifications and variations that come within the scope of the appended claims and their equivalents. In particular, it is explicitly contemplated that any part or whole of any two or more of the embodiments and their modifications described above can be combined and regarded within the scope of the present invention.

What is claimed is:

1. A communication device, comprising:
a communication module;
a cover glass covering the communication module and having a transparent window; and
an antenna,
wherein the antenna includes:
a first antenna pattern that is looped and formed on a top surface or a bottom surface of said cover glass; and
a second antenna pattern beneath the first antenna pattern and capacitively coupled with the first antenna pattern, and
wherein a resonant frequency of the antenna is determined by the first antenna pattern and the second antenna pattern.

2. The communication device according to claim 1, wherein the second antenna pattern functions as a feed unit.

3. The communication device according to claim 1, wherein a ground unit is arranged beneath the second antenna pattern.

4. An electronic timepiece, comprising:
the communication device according to claim 1; and
a display unit that displays time, the cover glass covering the display unit.

5. The electronic timepiece according to claim 4, further comprising:
a ring-shaped member arranged beneath the cover glass,
wherein the first antenna pattern is formed on the bottom surface of the cover glass, and
wherein the second antenna pattern is formed on the ring-shaped member.

6. The electronic timepiece according to claim 5, wherein a non-conductive material is arranged between the cover glass and the ring-shaped member.

7. The electronic timepiece according to claim 4, further comprising:
a ring-shaped member arranged beneath the cover glass,
wherein the first antenna pattern is formed on the top surface of the cover glass, and
wherein the second antenna pattern is formed on the top surface of the ring-shaped member.

8. The electronic timepiece according to claim 4,
wherein the first antenna pattern is formed on the top surface of the cover glass, and
wherein the second antenna pattern is formed on the bottom surface of the cover glass.

9. The electronic timepiece according to claim 4, further comprising:
a ring-shaped member arranged beneath the cover glass,
wherein the first antenna pattern is formed on the bottom surface of the cover glass, and
wherein the second antenna pattern is formed on the bottom surface of the ring-shaped member.

10. The electronic timepiece according to claim 5, further comprising:
a pin that contacts the second antenna pattern,
wherein the pin is arranged at a position away from a crown and side switches.

11. The electronic timepiece according to claim 6, further comprising:
a pin that contacts the second antenna pattern,
wherein the pin is arranged at a position away from a crown and side switches.

12. The electronic timepiece according to claim 7, further comprising:
a pin that contacts the second antenna pattern,
wherein the pin is arranged at a position away from a crown and side switches.

13. The electronic timepiece according to claim 5, wherein the first antenna pattern is circular and includes wide portions and thin portions arranged in a repeating manner at 30° intervals.

14. The electronic timepiece according to claim 6, wherein the first antenna pattern is circular and includes wide portions and thin portions arranged in a repeating manner at 30° intervals.

15. The electronic timepiece according to claim 7, wherein the first antenna pattern is circular and includes wide portions and thin portions arranged in a repeating manner at 30° intervals.

16. The electronic timepiece according to claim 5, wherein the second antenna pattern is circular and divided into a plurality of patterns at intervals substantially equal to 45°.

17. The electronic timepiece according to claim 6, wherein the second antenna pattern is circular and divided into a plurality of patterns at intervals substantially equal to 45°.

18. The electronic timepiece according to claim 5, further comprising:
a pin,
wherein the second antenna pattern is circular and divided into a plurality of patterns at intervals substantially equal to 45°, and
wherein the pin contacts one of the plurality of patterns of the second antenna pattern.

19. The electronic timepiece according to claim 6, further comprising:
a pin,
wherein the second antenna pattern is circular and divided into a plurality of patterns at intervals substantially equal to 45°, and
wherein the pin contacts one of the plurality of patterns of the second antenna pattern.

20. An antenna device, comprising:
an antenna line for receiving radio waves from a satellite;
a feed line that is arranged beneath the antenna line and coupled with the antenna line;
a feed point that contacts the feed line; and
a ground line formed centered around a position that has been rotated in a direction +45° or +225° from the feed point about a prescribed rotational axis.
